(19) United States
(12) Patent Application Publication
(10) Pub. No.: US 2003/0133552 A1
(43) Pub. Date: Jul. 17, 2003

(54) Method and apparatus for integrating disparate telecommunication operational support systems (OSS) and streamlining business processes using a software platform

(76) Inventors: Shyam Pillai, Stamford, CT (US); Avi Basu, Norwalk, CT (US); Mark Trudeau, Franklin Lakes, NJ (US)

Correspondence Address: HARRINGTON & SMITH, LLP, 4 RESEARCH DRIVE, SHELTON, CT, 06484-6212, US

(21) Appl. No.: 10/213,517

(22) Filed: Aug. 6, 2002

Related U.S. Application Data
(60) Provisional application No. 60/310,661, filed on Aug. 7, 2001.

(51) Int. Cl. H04M 15/00

(52) U.S. Cl. 379/114.2; 379/114.01

(57) ABSTRACT

Disclosed herein are methods and apparatus for the integration of Telecommunication System Operator Support Systems, providing for increased efficiency, data integrity and other benefits. The teachings herein provide for a software based solution that includes, but is not limited to, a graphical user interface engine for defining rules-based processes, a process management module, and a back-end services integration engine.

### CLAIM OF PRIORITY FROM COPENDING PROVISIONAL PATENT APPLICATION

Priority is herewith claimed under 35 U.S.C. §119(e) from co-pending U.S. Provisional Patent Application No. 60/310,661, filed Aug. 7, 2001, entitled “Method And Apparatus For Integrating Disparate Telecom Operational Support Systems (OSS) And Streamlining Business Processes Using A Software Platform,” by Shyam Pillai, Avi Basu, and Mark Trudeau. The disclosure of U.S. Provisional Patent Application No. 60/310,661 is incorporated by reference herein in its entirety.

### TECHNICAL FIELD OF THE INVENTION

This invention relates to the integration of electronic and software systems and subsystems used in the operation of a telecommunications enterprise, such as a wireless service provider.

### BACKGROUND OF THE INVENTION

Telecommunication System Operators, herein TSO, use multiple operational support systems in the normal conduct of their business. That is, a number of individual systems that offer functionality to address specific areas of the business are typically required. For example, a network operator will rate and bill customer's calls using a billing system; manage warehouses and inventory using a separate inventory system; and accounting information on at least one financial system. Typically, the operational support systems, herein OSS, include a variety of technologies, platforms and architectures as they are often acquired over a period of time as well as from a number of different vendors. Problems faced in the enterprise of a TSO may be better understood using the following illustrations and explanation.

Many transactions in a TSO enterprise involve more than one specific system. For example, when a customer payment is recorded, the payment information will have to be recorded in the financial system, billing system and a Customer Relationship Management (CRM) system. Thus, it often requires that the TSO, or “user” must enter the same data in multiple systems to complete one transaction. Examples of support systems include, but are not limited to, point of sale terminals, billing systems, finance systems, fraud detection systems, credit management systems, inventory control systems, procurement systems, CRM systems, as well as back-end interfaces to system hardware. Multiple data entry necessarily results in scattered data, increased probability of human error, duplication of efforts, extended transaction duration and ultimately inefficient and expensive processes.

While TSO have been able to manage their operations with limited integration between support systems, it is increasingly difficult to continue in this manner. This is due to the increase in the number of products and services, increased competition, convergence of services and newer generation technologies being deployed. As the number of products offered and sales channels has grown, the complexity of successful business has also grown.

Limitations arising from operation using the typical array of separate systems is illustrated by the following examples or considerations. TSO employees must be trained in multiple systems to be able to complete transactions; TSO employees must use multiple systems resulting in duplication of effort, as well as duplication and scattering of important data; it is difficult, and therefore costly to effectively implement system wide functional controls (e.g., changes in policies); changes to business processes typically requires involvement of different systems vendors and the corporate information technology department; and, changes to one system typically drives changes in other systems.

FIG. 1A provides an illustration of some of the systems involved in a present day TSO enterprise, and relationships between the systems. Included in FIG. 1A are exemplary Legacy Systems 10 that include, but are not limited to, billing systems, point of sale equipment and financial systems. Understandably, these systems 10 may have a data relationship with other systems, such as Client Server Systems 20. The Client Server Systems 20 may be used to manage, among other things, credit and inventory. In this illustration, the Legacy Systems 10 have further relationships with Web Based Systems 30, such as customer relationship management and fraud detection systems. These various systems (Legacy Systems 10, Client Server Systems 20, Web Based Systems 30, and others) relate to the Network Elements 40 of the cellular system architecture. Some of these Network Elements 40, and associated relationships, are shown in FIG. 1B.

FIG. 1B provides a general overview of integrated service architectures in the context of an exemplary 2.5G/3G cellular system, in order to provide for a better understanding of this invention. Typically, an integrated service architecture includes two distinct elements, which can generically be called the Voice Controller Node 100 (VCN) and the Data Controller Node 150 (DCN). While the VCN 100 controls the initiation and termination (and possibly the forwarding) of voice calls, the DCN 150 controls the actual flow of data packets, as well as the various data-based services, available to a specific cellular customer. Both of these nodes, however, access a common database, which stores information about the customer's service profile and access privileges. This centralized database is typically referred to as a Home Location Register 175 (HLR), and contains rules governing the customer's ability to access different forms of voice and data services, as well as additional intelligent features such as roaming support, call or packet forwarding, etc. For example, the HLR 175 might indicate that Customer A can make international calls to only selected countries and have access to the entire Internet 190, while Customer B can make only domestic calls and also access only certain pre-selected Internet 190 sites.

It should be noted that different proposed architectures refer to the VCN 100 and DCN 150 by distinct names. The VCN 100 is commonly referred to as the Mobile Switching Center 100 (MSC) in a majority of systems. The MSC 100 is typically a switch that controls all signaling involved in the control of voice traffic. The DCN 150, which is typically a new element not found in previous cellular architectures, is also known as the Packet Data Serving Node/Home Agent 150 (PDSN/HA). The PDSN/HA 150 is an element of the 3GPP2 architecture, and is also found in the 3GPP-GPRS architecture, where it is known as the Gateway Serving Node 150 (GGSN).

In order to provide clarifying and illustrative examples, nomenclature associated with the 3GPP2 architecture is referred to herein, however, one skilled in the art will recognize that the teachings herein apply equally to alternative architectural standards and models.

In the 3GPP2 architecture, both the MSC 100 and the PDSN 150 use message sets defined in the IS-41 protocol to retrieve the customer's access profile from the centralized database, referred to herein also as the HLR 175. To support data services, the information fields in the HLR 175 have been extended from their conventional set, and include additional data-specific fields, examples of which could be IP addresses or data-specific handset IDs, access control lists (ACLs) indicating web-sites that the user is authorized to access, or the maximum quantity of permitted traffic (in bytes).

In order to more fully comprehend problems and limitations of existing systems, and to provide context for the invention disclosed herein, consider the following aspects of a TSO enterprise. These aspects involve (1) present techniques for combined and integrated billing and rating of both voice and data services in a distributed wireless cellular architecture; (2) present techniques for supporting prepaid integrated voice and data services in cellular network architectures; (3) present techniques for integrated provisioning of both voice and data services in wireless cellular networks; and, (4) issues concerning support of dynamic modification of customer access profiles in a cellular telecommunications architecture that supports both voice and data.

Consider first the current techniques for tracking usage and billing customers for both voice and data services.

In next-generation cellular architectures, voice and data traffic are typically controlled from a single centralized database, but by different network switches and controllers. Moreover, the details about voice and data resource consumption are provided by these network elements in very different formats, and quite often, to different billing and rating systems. While each billing system may be capable of computing the customer's bill for the specific services that it manages, this independent-billing architecture proves to be a serious impediment in the activation of services that offer combined voice and data access.

In order to provide the TSO with an ability to bill the customer for the consumption of appropriate resources, the cellular system architecture must allow for specific nodes to collect information about the customer's voice and data usage, and then export such information to specialized billing systems 110, 160. The billing systems 110, 160 apply the appropriate tariffs and rates to determine the resulting bill. In the cellular architecture discussed in FIG. 1B, the usage information for voice and data traffic are monitored and collected at two separate nodes: the VCN (MSC) 100 which collects the usage information for voice, and the DCN (PDSN) 200 which collects the appropriate information for data. Moreover, this usage information is usually collected by two independent billing systems 110, 160. A Voice Billing System 110 computes the charges for voice calls, while a Data Billing System 160 computes the charges for data applications. Limitations arising from the cellular system architecture as described in FIG. 1B are illustrated by, but are not limited to, the following examples.

First, the usage information for voice and data services is collected independently at two separate nodes. This usage information is not directly available to the HLR 175, which is simply a repository for various policies.

Second, voice and data traffic typically have very different formats in which their usage information is reported. For voice traffic, the parameters of interest are primarily the length of the call and the destination number, since charges are usually billed based on the duration and source/destination of a call. In contrast, data traffic is typically further distinguished by the specific application (e.g., web-browsing or email), the content provider's identifier (such as preferred web servers or content providers) and the total resource consumption (in bytes, not just in minutes). This is especially true for next-generation wireless interfaces, where different users can experience different data rates for their packet traffic; accordingly, the duration of a session does not, by itself, provide sufficient information to determine the appropriate charges. Typically, voice calls are reported as Call Detail Records (CDR) in various formats including CIBER, while data session usage is reported in different formats, including the popular IP Detail Record (IPDR) standard.

A third limitation arises from the fact that voice and data usage information can be reported to different billing systems. A typical reason why this happens is the potential for provider to have multiple billing systems, each geared towards processing a specific form of network usage. As an example, operators often have a legacy billing system 10 that was designed to bill only for voice calls and voice-telephony related features; and such systems do not have the capability to parse data usage records or rate them. To preserve their existing investment, an operator may simply wish to purchase an IP-billing system, leaving the legacy system 10 to rate voice calls.

One other exemplary limitation arises from the fact that billing systems 110, 160 often perform the retrieval and processing of such usage information in an off-line (non real-time) manner. Hence, it can indeed be days, and even weeks, before a specific call or data usage is logged by the operator's business support systems.

As a result, the drawbacks of this form of billing should be clear. For example, this form of billing does not readily allow the provider to define services where charges are dependent on the combination of the customer's voice and data usage records. The inability to offer such bundled services has the potential to be a serious disadvantage in the future integrated cellular environment. Such bundled services can be expected to require the charges for voice calls to be a function not just of a customer's voice usage, but also of data usage, and vice-versa.

Since each billing system 110, 160 is unable to process anything other than the records it has been designed to process and rate, a solution must be found that either modifies the charging rates based on an integrated view of the customer's combined data and voice usage, or is able to convert one form of resource usage into an equivalent usage value for another resource type (thereby allowing one system to effectively perform the billing for multiple services).

An example that illustrates the need to modify the charging rates in an integrated service environment, assume an operator offers the following integrated service plan: If the data usage is less than 100 MB per month, voice calls are charged at the rate of 25 cents/minute, while data traffic is charged at 50 cents/MB. However, if the data usage exceeds 100 MB, the voice calls are charged at a lower rate of 10 cents/minute, while the data usage rate remains unchanged. Thus, the voice billing system 110 effectively requires an update on the charging rate of the voice calls at either 25 or 10 cents a minute, based on a separate data source that monitors the combined voice and data usage.

In prepaid services for wireless cellular networks, the customer pays in advances for a designated quantum of resources. The network elements effectively coordinate with different provisioning and user support systems to dynamically monitor the resource consumption in real-time; once the designated levels of resource use are exceeded, the network elements terminate ongoing connections to prevent unauthorized use. Prepaid services are a key growth area for the wireless cellular business. The main challenge for this service is to ensure that the network elements and databases are always configured with the latest data on the residual resources (for example, remaining voice call minutes or remaining MB of data packet) available to each user; once such resources are exhausted, the network must effectively deny further access to the customer.

In next-generation cellular architectures, voice and data traffic are typically controlled from a single centralized database, but by different network switches and controllers. While each individual switch can track the resources consumed by a specific service, there is no entity that acts as a single monitoring entity to track the composite use of resources. Accordingly, it is a challenge to offer prepaid services where the service is specified in a combination of variable amounts of voice and data usage.

In conventional pre-paid services for voice, the VCN 100 (MSC) does not just route an ongoing voice-call, it also maintains a separate live connection to another intelligent network entity (such as a real-time billing system 110) that determines when the user's permitted quota of minutes is exhausted. Once this quota is indeed exhausted, the MSC 100 terminates the connection. To further disable any subsequent access, the MSC 100 (or alternatively the real-time billing system 110) must immediately update the HLR 175 database with modifications to the access profile. Thus, the proper handling of pre-paid services is challenging, since they require real-time coordination between the network voice switches, the billing systems and the network databases.

In the integrated service model, a user can purchase pre-paid services for both voice and data. It is relatively easy to manage the case where voice and data usage quantities are specified independently (e.g. a pre-paid service where the user obtains 100 minutes of voice and 100 MB of data services). Such a scenario, at least conceptually, is equivalent to replicating the real-time requirements at the data switch 150 (DCN). In addition to the MSC 100, the PDSN 150 also meters data traffic (not just in minutes, but also in the quantity of data transmitted) and maintain live communication with an appropriate configuration agent.

A problem with existing techniques arises when the prepaid service is specified in the form of combined voice and data usage. As a specific example, consider the case where the user buys a prepaid service that entitles the user to the receipt of either 100 minutes of voice and no data, 50 minutes of voice and 50 MB of data, or no voice but 100 MB of data. It can be seen that the independent control model breaks down in this case, since each controlling entity has no knowledge of the user's resource consumption on an alternative path (e.g., the PDSN 150 does not know whether the user is making a voice call), it is unable to offer a coordination mechanism to control unauthorized access.

Pre-paid billing for data services is additionally more complex because of the heterogeneity of the data application set. Different users can also have different traffic rates that vary dynamically. Billing rates can also depend on other parameters such as the number of bytes, the number of higher-level abstractions (number of email or SMS messages) and others. These challenges pose an additional burden on the network elements, in particular the HLR 175. The HLR 175 is typically a database that may not have the capability to posses access control information at very fine levels of granularity. Thus, the HLR 175 may be able to enforce a policy that provides support for only TCP traffic (no UDP connections), but might not be able to enforce a policy that bars HTTP proxy traffic but allows HTTPS traffic.

Notably, several disadvantages of the existing techniques include, but are not limited to, the difficulty encountered when attempting to define services where the allowable usage on one path (e.g. voice) depends on the usage on an alternative path (data), since the real-time traffic control for pre-paid data and voice services is administered by different elements; the HLR 175 may not be always able to store arbitrarily fine details of permitted usage, especially for data usage; moreover, there is no mechanism by which one of the network switches 100 is able to regulate the access privileges for traffic on another path.

Consider now the following regarding the integrated provisioning of voice and data services in a wireless cellular network.

With the advent of 2.5G and 3G cellular networking standards, network operators will be able to offer both conventional voice and packet-based data services to individual customers. In these next-generation cellular architectures, voice and data services are, however, often provisioned using two distinct provisioning systems 600, 650 (FIG. 1B); moreover, the actual services are controlled by different network elements and switches. Provisioning a single user for both voice and data services thus effectively decomposes into logically distinct provisioning operations, each catering to a specific service category (such as voice, email, SMS etc.). The lack of coupling between these different configuration systems, however, presents a major hurdle to the cellular provider's ability to provision, sell and manage these various services under a unified framework.

The ability to manage and configure multiple services using a single management mechanism avoids the duplication and redundancies associated with independent definitions of voice and data offerings. From a customer viewpoint, multiple independent configuration mechanisms would require either the operator or the customer to submit the user's personal information multiple times to different business systems. More importantly, service bundling allows an operator to combine voice and data access into packages geared towards the market need. Thus, for example, the operator may offer to sell a service that, for example, offers 500 minutes of voice and 100 MB of data, in a combination plan for a single monthly payment.

The MSC 100 and the PDSN 150 nodes are typically involved in the actual processing of voice calls and the actual forwarding of data packet, respectively. The configuration of users typically involves network databases, such as the HLR 175. Configuration utilities and systems focus on setting the various fields in the HLR 175 (and other databases, such as, but not limited to, the Equipment Identity Register or EIR) to enforce the security and access control policies specified in the customer's service description. To provide support for new data service-related semantics, the HLR 175 databases are typically upgraded to store additional parameters. For example, a GPRS-based HLR 175 would include fields such as the GPRS ID, IP address for Internet 190 connectivity, list of web sites to which access is restricted, address of the packet billing system and others. These fields are often set by a configuration system specifically geared for GPRS services. Similarly, voice-centric fields are often set by the voice configuration system. There is, however, no central system that stores disparate views of a customer's multiple services in a single profile, or that automates the process by which the customer's service choices result in a coordinated configuration of the various network databases by the individual configuration systems.

One of the obstacles to such an integrated configuration mechanism is the use of different processes for configuring voice and data services. For example, configuring a voice service would require the operator to assign the customer a phone number and a handset identification, and also set up voice-specific entries such as support for call forwarding, three-way calling or other calling features. Alternatively, the GPRS (data) provisioning system could also associate the handset identification with the GPRS identification, an IP address and packet-specific entries such as email support, WAP services and other similar entities. Due to the distinct nature of these configuration processes, the configuration of voice and data services is often performed by different vendor systems. It should be clear that some form of coordination between the configuration processes is lacking as, for example, the GPRS configuration system is not aware of the handset identification allocated by the voice configuration utility.

Further, some subset of the configuration parameters maybe shared resources and should be identically allocated across all systems. Moreover, user service configuration is not simply a matter of allocating entries in network databases; configuration of user services also requires the creation of new entries in additional business and operations support systems, such as billing systems 110, 160, customer care systems and others. Since voice and data may require different end systems for these functions (e.g., the billing systems 110, 160 for voice and data are often independent), it is also necessary to configure entries in multiple such systems in a coordinated fashion. Prior to this invention such capabilities were lacking.

While both voice and data services are supported in 2.5/3G cellular networks, the nodes and agents used to control information flow for these services are typically separate. While voice-traffic is circuit-switched (a dedicated connection reserved for the entire duration of a call), data traffic is packet-switched (with packets belonging to different streams being multiplexed to achieve higher efficiency).

The architecture must allow for specific nodes to collect information about the customer's voice and data usage, and then export such information to specialized billing systems 110, 160 that apply the appropriate tariffs and rates to determine the resulting bill. In the cellular architecture discussed above, the usage information for voice and data traffic are monitored and collected at two separate nodes: while the VCN 100 (MSC) collects the usage information for voice, the DCN 150 (PDSN) collects the appropriate information for data. Moreover, this data is usually collected by two independent billing systems, where the system 110 computes the charges for voice calls while the other system 160 computes the charges for data applications. To understand the limitation of this functional architecture, it is important to appreciate the following points.

1. The usage information for voice and data services is collected independently at two separate nodes. This usage information is not directly available to the HLR 175, which is simply a repository for various policies; 2. Voice and data traffic typically have very different formats in which their usage information is reported. For voice traffic, the parameters of interest are primarily the length of the call and the destination number, since charges are usually billed based on the duration and source/destination of a call. In contrast, data traffic is typically further distinguished by the specific application (e.g., web-browsing or email), the content provider's identifier (such as preferred web servers or content providers) and the total resource consumption (in bytes, not just in minutes). This is especially true for next-generation wireless interfaces, where different users can experience different data rates for their packet traffic. Accordingly, the duration of a session does not, by itself, provide sufficient information to determine the appropriate charges. Typically, voice calls are reported as Call Detail Records (CDR) in various formats including CIBER, while data session usage is reported in different formats, including the popular IP Detail Record (IPDR) standard; 3. Voice and data usage information is not just collected by separate nodes, but can also be reported to different billing systems 110, 160. This can often happen because the conventional (legacy) billing system 10 does not provide support for rating data traffic, and the operator may have economic interest in maintaining the existing billing system 10. In such instances, a different billing system is installed to specifically handle data-centric usage. Moreover, it should be noted that retrieval and processing of such resource consumption information often happens off-line and is not a real-time process. Hence, it can be some period of time before a specific call or data usage is logged by OSS.

One significant drawback of present functional architecture is that it does not allow for dynamic modification of customer service profiles or the creation of service profiles that combine both voice and data access into a single integrated service. The ability to offer such integrated or bundled services is an important service offering by a wireless cellular service provider, especially in a competitive environment where such bundled offerings serve as a way to distinguish oneself from the competition. In conventional operations, there is no central entity that monitors both voice and data usage. Accordingly, it is difficult for the operator to define policies where the levels of data and/or voice services depend dynamically on the combined voice and data usage. The profile information in the HLR 175 is typically updated only when a customer modifies his service profile, the HLR 175 serving as essentially a static database that contains long-term entries. To provide for dynamic modification of customer profiles, it would be useful to monitor the customer's resource usage and then update the HLR 175 entries in a much more dynamic fashion. This is especially true in situations where the billing engines 110, 160 collect data and process them in non-real time fashion, making any adaptation of the access privileges of the customer impossible within any useful time frame. Prior to this invention this important need was not adequately addressed.

For example, consider a profile that would allow a customer 500 MB worth of emails per month, and unlimited local calling (within the operator's region), as long as the customer's email access was below this 500 MB limit. However, on exceeding this limit (on a data service), the operator would desire to block the customer's ability to make voice calls. In this example, the fundamental feature is the definition of a context-dependent user profile, where the customer's range of voice and data services is not only dynamic, but is also functionally dependent on the customer's combined usage of both voice and data services.

The foregoing examples and considerations hint of and describe a variety of problems with use of a non-integrated structure of support systems. It can be appreciated that many other or further complications can arise in this type of arrangement. For example, licensing issues may further exacerbate any of the limitations.

What is needed is an effective method and apparatus for the integration of Telecommunication System Operator support systems. That is, a need exists for a method and a system that provides for the ability to create interfaces quickly and easily between disparate systems, for a method and a system that provides flexibility for modification of interfaces without requiring additional coding, and for a method and a system that provides for and accommodates multiple architectures, protocols, and languages.

### SUMMARY OF THE INVENTION

The foregoing and other problems are overcome by methods and apparatus in accordance with embodiments of this invention.

Disclosed herein are methods and apparatus for integrated management of Telecommunication System Operators Support Systems (OSS). The invention disclosed herein includes a user configurable platform that may be adapted for use with a variety of separate and distinct support systems, thus providing for effective flow of data between the support systems, while providing for data integrity and efficient operation of the telecommunication system.

An aspect of this invention includes a software based platform for integration of a Telecommunication System Operator's (TSO) electronic support systems. The platform includes, but is not limited to, three major components, which together provide for the desired integration of Operator Support Systems (OSS).

The first component includes a framework to customize a graphical user interface that can serve, among other things, as the client for all or some of the integrated back-end systems. In a preferred embodiment, the framework includes a browser based, device independent component that can be customized to fit the different needs of the user community within an enterprise. This component is designed to allow non-technical users to create and modify the user interface screens. The first component is integrated with other components of the platform.

The second component includes, among other things, a module for mapping of business processes, and linking of front-end and back-end services. This component includes a rules engine and a design studio to create the processes. The second component is integrated with the other components of the platform.

The third component includes an integration engine that, among other things, manages data translation, formatting and messaging.

Together, the components and other aspects of the platform provide a transparent and comprehensive layer for integration of OSS. The platform may include suitable adaptors and other components to provide for communication between system elements.

In the preferred embodiment, the platform is used to manage a wireless telecommunication system that provides various resources to customers, such as voice and data transmission resources. However, the teachings herein may be applied to other types of systems, and are not limited for use with wireless telecommunication systems. Furthermore, while the teachings herein are disclosed in terms of presently preferred embodiments, variations in these teachings may occur while remaining within the scope of this invention. Therefore, it is considered that the embodiments provided herein are illustrative only, and are not to be considered limiting of the invention.

### BRIEF DESCRIPTION OF THE DRAWINGS

The above set forth and other features of the invention are made more apparent in the ensuing Detailed Description of the Invention when read in conjunction with the attached Drawings, wherein:

FIGS. 1A and 1B, collectively referred to as FIG. 1, show aspects of a cellular system architecture, where FIG. 1A illustrates various components and aspects of relationships in a Telecommunication System Operator enterprise, and FIG. 1B illustrates various components and aspects of relationships in a cellular system architecture;

FIG. 2 is a logic diagram of message flow related to integrated billing;

FIG. 3 is a logic diagram of message flow related to prepaid services;

FIG. 4 is a block diagram of an Integrated Configuration Engine (ICE) in relation to other system components;

FIG. 5 is a logic diagram of message flow related to policy management;

FIG. 6 is a diagram of a process-centric model; and

FIG. 7 is a block diagram of a platform for integration of a Telecommunication System Operator's (TSO) electronic and software support systems.

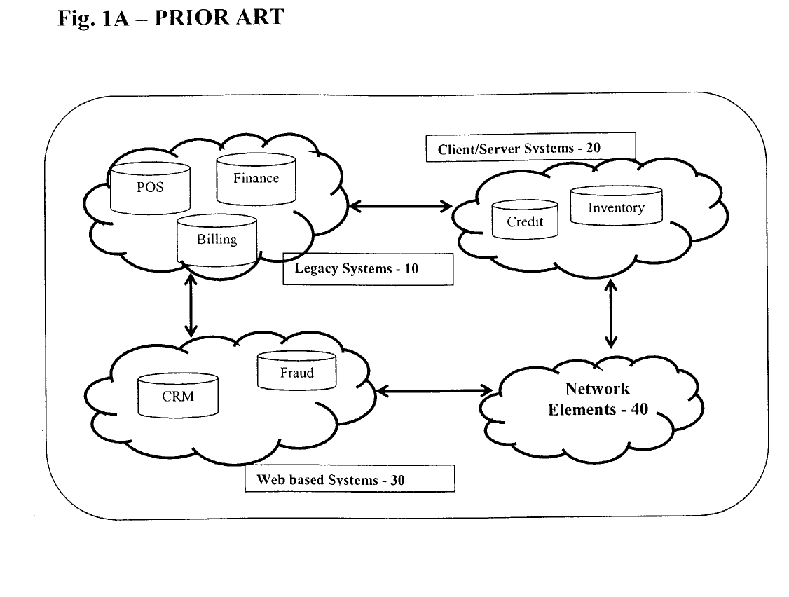

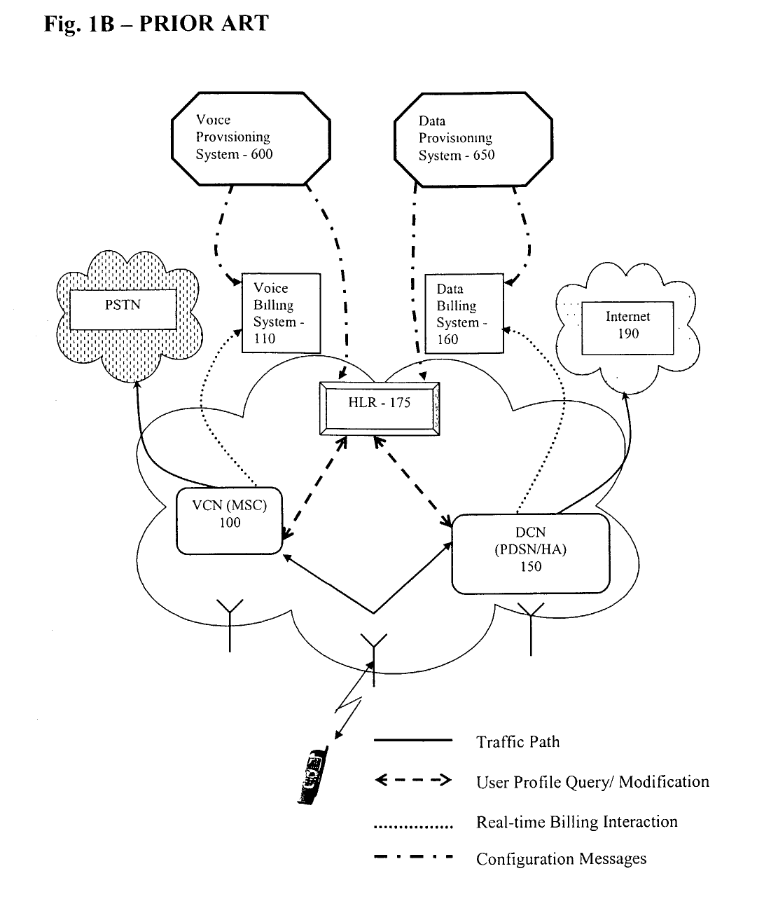

### DETAILED DESCRIPTION OF THE INVENTION

Disclosed herein are methods and apparatus for integrated management of Telecommunication System Operator's Support Systems (OSS). The invention disclosed herein includes a user configurable software platform that may be adapted for use with a variety of separate and distinct support systems, thus providing for effective flow of data between the support systems, while providing for data integrity and efficient operation of the telecommunication system.

The following terms or acronyms, as used herein, are now defined for clarity. “OSS” refers to Operator's Support Systems, and includes all components necessary for the execution and implementation of a Telecommunication System Operator's business. This includes, but is not limited to unique hardware components, software, dataforms and other systems. “ONEVIEW” refers to the methods and apparatus of this invention for the integrated management of Telecommunication System Operator's Support Systems (OSS). “TSO” refers to a Telecommunication System Operator, or operation of a telecommunication system. “Carrier” is synonymous with TSO. “Policy” refers to rules, such as, but not limited to, those associated with billing of a customer, and are commonly referred to as a “calling plan.” “XML™” is a product of Oracle Corporation of Redwood Shores, Calif. XML (Extensible Markup Language) is a high-performance storage and retrieval technology. Although the invention herein is disclosed in terms of XML, and structures thereof, this invention is not limited only for use with XML, and other storage and retrieval technologies can be employed.

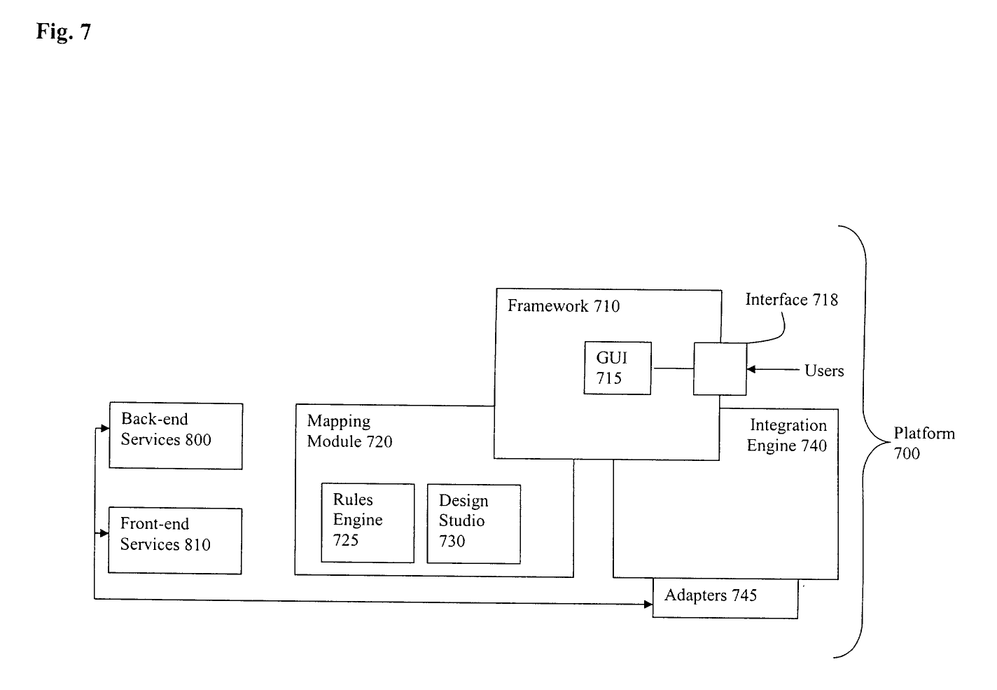

Referring to FIG. 7, there is shown a block diagram of a platform 700 for integration of a Telecommunication System Operator's (TSO) electronic support systems. The platform 700 includes, but is not limited to, three major components, which together provide for the desired integration of Operator Support Systems (OSS).

The first component includes a framework 710 to customize a graphical user interface (GUI) 715 that can serve, among other things, as the client for all or some of the integrated back-end systems 800. In a preferred embodiment, the framework 710 includes a browser based, device independent interface component 718 that can be customized to fit the different needs of the user community within an enterprise. The interface component 718 is designed to allow non-technical users to create and modify the user interface screens. Support of Wireless Markup Language (WML) offers mobility functionality as the screens created can be accessed over a wireless device such as a PDA. The first framework component 710 is integrated with other components of the platform 700.

Aspects of the first component include, but are not limited to: a presentation service that provides display and formatting based on type of access device (e.g. PC, cellular phone or PDA) used for the service; content configuration and management that provides for user defined content, and further allows creation or alteration of personalized content from units of information and also rapid content definition through use of templates provided as pre-packaged services. This further provides for grouping of data elements into a user interface. These interfaces can be sequenced into workflow for performing business functions and also tailored to different web-access devices. A user management function provides for facilities to create users, define roles and access rights for both content definition and service request; request fulfillment provides for service to integrate user request through response via integration with business functions and back-end systems and services 800; user data store to provide facilities for the user (administrator and end user) to store information including, but not limited to, elements, element mappings, content, content flow, user access and authentication. Also provided by the framework 710 are system services to provide for transaction integrity, foreign language support, error reporting and logging, as well as security. The framework component 710 may also be referred to as a process integration engine.

The second component of the platform 700 includes a module 720 for the mapping of business processes, and linking to front-end 810 and back-end 800 services. The mapping module 720 includes a rule engine 725 and a design studio 730 to create the processes. The mapping module component 720 is integrated with the other components of the platform 700.

Aspects of the mapping module component 720 include, but are not limited to: a process designer to provide for a graphics interface to define or alter and store business process definitions; rule definition and event handling to allow definition of process rules and business rules and event handling to provide for automated or user action; process mapping to provide user process mapping and authentication abilities including data mapping for the processes defined; and linking to provide for interfacing business processes to both front-end 810 and back-end 800 services. The linking and interfacing is flexible to accommodate new/modified process flows and back-end service 800 interface changes.

The third component includes an integration engine 740 that, among other things, manages data translation, formatting and messaging. In the preferred embodiment the integration engine 740 uses XML as the data interchange format. Integration to the font-end and back-end systems 810, 800 is handled via adaptors 745 providing for data and messaging interchange. The integration engine 740 preferably employs Enterprise JavaBeans™ (EJB) (Trademark of Sun Microsystems Corporation) components deployed in an industry standard application server, and uses Message Oriented Middleware (MOM) and the adaptor framework as the means of integrating the OSS into the system. The integration engine 740 operates to expose standard interfaces to various OSS, and supports transaction, error handling, and logging capabilities. The integration engine 740 is integrated with the other components of the platform 700.

Aspects of the integration engine 740 include, but are not limited to: (1) back-end system 800 integration to provide integration services for seamless support of disparate systems, platforms and technologies through use of integration agents supporting business rules and data transformation rules; (2) adaptability and scalability to provide for integration services that are scalable to new or changed interfaces to enterprise services through support of open adapters to enterprise systems; and (3) reliability to provide data flow-through that is reliable and consistent and user services that are met within reasonable service delivery cycles. The integration engine 740 further provides for ability to handle fail over and maintain user session continuity.

Together, these components and other aspects of the platform 700 provide a transparent and comprehensive layer for integration of OSS. The platform 700 may include the various adaptors 745 and/or other components as necessary to provide for communication and therefore integration between system elements. This communication is achieved using Java™ Message Service (JMS) (Trademark of Sun Microsystems Corporation) based messaging architecture that includes support for the UsageQuery and RateConfigure message primitives. The rule engine 725 disclosed herein preferably employs XML message formats to determine appropriate rating rules to be applied. The platform 700 further allows users to define customer specific policies using a drag-and-drop utility via the GUI 715. Accordingly, the rules associated with the rules engine 725 can be specified by the drag-and-drop utility, or a similar utility. The process management component is responsible for deriving the rule set from the GUI 715 representation, and forwarding this as appropriate.

Aspects of the invention are disclosed herein in the context of 2.5G/3G cellular system architecture, and certain functions of the cellular system. An introduction to 2.5G/3G cellular system architecture is provided, in order to describe and provide context for the teachings of this invention. Specific aspects of existing systems are reviewed in greater depth herein, also to provide context and introduction to aspects of this invention.

It should be recognized that modifications to the disclosure herein, in the form of additional techniques, components and/or devices, are considered to be within the scope and teachings of this invention, and all embodiments including such modifications are thus within the ambit of this disclosure.

Disclosed herein are methods and apparatus for using the integration platform 700: to support combined and integrated billing and rating for both voice and data services in a distributed wireless cellular architecture; to support prepaid integrated voice and data services in cellular network architectures; to provide for the integrated provisioning of both voice and data services in wireless cellular networks; to support dynamic modification of customer access profiles in a cellular telecommunications architecture that supports both voice and data; and for creating unified business processes that integrate transactions in multiple disparate systems in the telecommunications industry using the intelligent software platform.

One aspect of this invention involves a method for using an integration platform to support combined and integrated billing and rating for both voice and data services in a distributed wireless cellular architecture, such as the one disclosed herein.

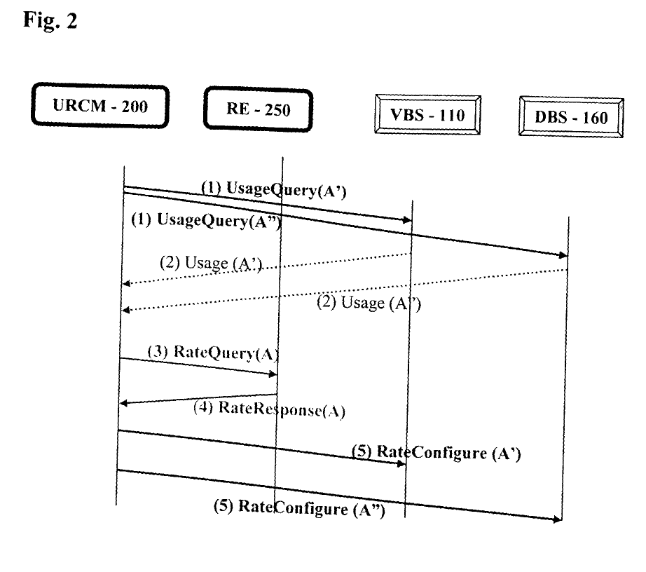

One aspect of the platform 700 includes a separate integration engine, referred to herein as a Universal Resource Consumption Monitor (URCM) 200 (FIG. 2), that tracks the customer-specific usage of disparate resources, and then applies pre-configured policies to instruct individual billing systems 110, 160 to apply the appropriate rating rules. The URCM 200 effectively maintains a single, unified view of the customer's total voice and data usage and also contains the rules that define how such combined usage affects the charging policy for each individual service. This software entity is responsible for querying one or more billing systems 110, 160 (or alternatively, the network control entities, the VSCC and the DSCC) and then combining the usage statistics into a single representation of the voice and data services accessed by the customer. After obtaining this information, the URCM 200 uses the rule database (rules engine 250) to decide which set of charging rules are currently applicable to the consumer. Finally, the URCM 200 notifies each individual billing system of its appropriate charging rules to obtain a consistent and unified customer bill.

Note that the URCM 200 is not itself a billing system. That is, the URCM 200 need not perform the actual billing specific functions, such as bill printing, archival or other functions. The URCM 200 serves as a way to inform each isolated system of the effect of other forms of resource usage on its specific rating policies. The URCM 200 is also not a typical billing system 110, 160 adaptor, since it does not necessarily convert one form of usage records into another format for a separate system. In one embodiment, the URCM 200 is characterized by adaptor functionality. In this embodiment, one way to achieve integrated billing would be to convert, for example, data usage records into an equivalent number of voice minutes (CDRs) and then feed these adapted records into the voice billing system. In preferred embodiments, the URCM 200 mediates between billing system policies and acts as a centralized controller to regulate appropriate rates on each system 110, 160.

One way of appreciating the difference between a conventional billing system 110, 160 mediation device and the URCM 200 is to understand that the URCM 200 typically would not process individual usage records. In the case of the sample profile discussed earlier, the URCM 200 instead tracks whether the total data usage has exceeded 100 MB, and then instructs the voice billing system 110 about the proper charging rate. The URCM 200 does not need to convert each and every IPDR (data usage record) into a CDR and then feed them to the voice billing system. By avoiding this form of record-level mediation, the URCM 200 offers a significant advantage in system scalability and a more intelligent way to provide integrated billing.

An important intermediate step in this integration process is not just to collect the disparate usage records, but also to unify them under a single customer view. This is desirable as different billing systems (and services) may refer to the user (customer) with different service-specific IDs. Thus, the voice records may be indexed by the user phone number, while the data records may be indexed by the customer's IP address. The URCM 200 may interface with additional user and equipment registries to correctly correlate such disparate identifiers.

A step in this integration process is thus the communication of modified rate schedules to individual billing systems 110, 160. The URCM 200 provides for export of such rating schedules to different systems in different formats. Appropriate message converters or adaptors may be included to facilitate export.

FIG. 2 provides a diagram of the logic of various elements, as well as a sequence of logical message flows and actions relating to functionality of integrated billing. In this example it is assumed that the URCM 200 communicates with the billing systems 150, 250 themselves. Rule Engine 250 (RE) is the component that determines the appropriate rates for different forms of services.

During operation of the platform 700, and at appropriate time instants (for example, daily, weekly or monthly, depending on the billing cycle), the URCM 200 queries the VBS 110 and DBS 160 for the service specific usage records for a specific user, A. Since the VBS 110 and DBS 160 may have different views of the same user, the URCM 200 may need to index the query by multiple identifiers. The multiple identifiers are shown as A′ and A″ in FIG. 2.

In response, the VBS 110 and DBS 160 respond with the appropriate usage information. In typical situations, messages from the VBS 110 and DBS 160 usually convey aggregate information, since most realistic policies are based on aggregate usage rather than individual calls/sessions.

The URCM 200 then aggregates this information into an Integrated Resource Consumption Record (IRCR) and queries the RE 250 to determine the appropriate charging rates and action. By applying the self-contained rules, the RE 250 determines the appropriate rates and replies to the URCM 200. The URCM 200 then informs each billing system 110, 160 of the appropriate service-specific rates, thereby enabling adaptive and integrated billing using multiple independent systems.

In the preferred embodiment of combined and integrated billing and rating for both voice and data services, the URCM 200 is implemented as an integral part of the cellular enterprise integration platform 700. Accordingly, a generic configuration method is provided, that includes, but is not limited to, logically distinct components.

As a first component of the generic configuration method, adaptors integrated to a backend integration system that allow the URCM 200 component to interface to various billing systems 110, 160 and, if necessary, to network elements (such as, but not limited to the HLR 175, MSC 100). This communication can be achieved using with the integration engine 740 using JMS-based messaging architecture, and includes support for the UsageQuery and RateConfigure message primitives.

The RE 250 is implemented using rules consistent with the URCM 200. In the preferred embodiment, XML rules are followed, and provide for XML message formats to determine the appropriate rating rules to be applied to a specific user. Thus, the URCM 200 can be implemented as an extended component of the integration engine 740 shown in FIG. 7.

The GUI 715 allows the user to define the customer-specific policies using the drag-and-drop utility. Therefore, the rules of the RE 250 can be specified accordingly. The GUI 715 is responsible for deriving the XML rule-set from the graphical user interface representation and forwarding this to a Unified Policy Controller component.

The advantages of the foregoing billing system disclosed will, in general, apply to both post-paid and prepaid billing systems. In various embodiments, additional system constraints may be added to support accurate pre-paid billing and configuration situations. For example, the Unified Policy Controller may be used in some embodiments to impose stringent messaging latency bounds on the EJB-based messaging sub-system, and may also use special primitives to establish dedicated connections to network elements (such as, but not limited to, the MSC 100 and PDSN 150) to support real-time tracking of a live call session. The details of such a real-time architecture may be handled and resolved on a case-by-case basis.

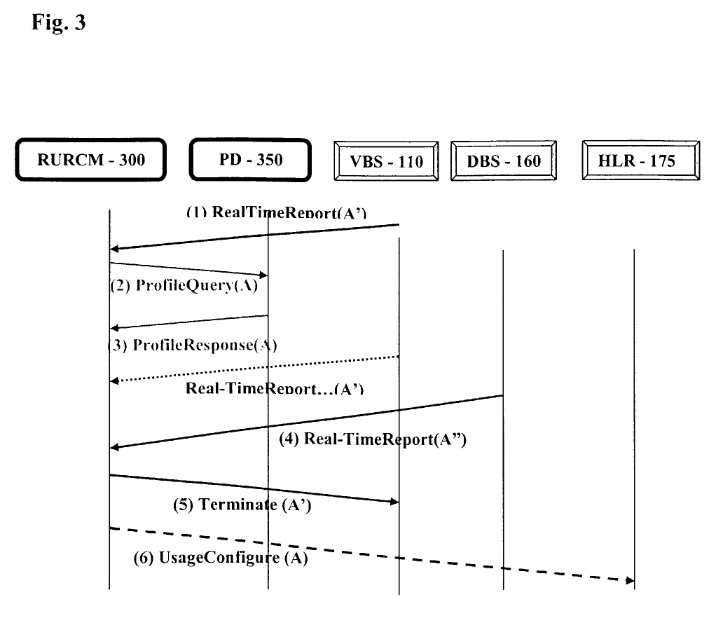

In order to overcome some of the above-described disadvantages of current techniques for management of prepaid services, a separate control element, a Real-Time Universal Resource Consumption Monitor (RURCM) 300 (FIG. 3) is provided to keep track of ongoing usage f system resources in real-time or approximately real-time, and applies prepaid service definitions to effectively regulate network usage. Moreover, the RURCM agent 300 is responsible for appropriately updating the network databases, notably the HLR 175, should such update be necessary.

The RURCM agent 300 is responsible for maintaining real-time active connections with the network elements, such as the MSC 100 and the PDSN 150, which regulate the user's ongoing calls/sessions. The RURCM agent 300 uses these connections to either periodically poll the network switches to obtain usage statistics, or to configure thresholds on the switches that trigger the switch to send live updates to the RURCM 300. Since the integration platform 700 may have other ongoing communication with the network elements, the RURCM 300 preferably is given the capability to flag its transmissions as higher-priority or time critical. A preferred solution assumes that the underlying integration platform 700 supports a messaging architecture that provides for differential priorities in message exchanges.

After obtaining real-time usage updates, the RURCM 300 is responsible for comparing the usage profile against the authorized limits specified by the pre-paid policy. The policy may be dynamic, in that different levels of resource usage on a specific path (e.g. data path) may impact the residual usage available on another path (voice). Thus, the RURCM 300 may be used to (in real-time) modify the thresholds, triggers and authorization levels that it may have communicated to the network elements. Thus, this method preferably is implemented using real-time (or substantially real-time) processing and communications support within the RURCM 300.

At the end of a specific call or session the RURCM 300 informs the HLR 175 database of any modifications necessary to the customer's access profile. Since it was shown that conventional HLR 175 implementations typically may not provide a sufficiently fine granularity in the access profile, the RURCM 300 control mechanism also serves as a “surrogate HLR” 175, effectively providing configurable and flexible filtering and access control support.

FIG. 3 shows RURCM 300 functionality through a messaging diagram that explains a typical exchange of messages. In addition to interfacing with the network elements 110, 160, 175, the RURCM 300 provides an interface with modules that store the pre-paid policies and that provide the necessary support for dynamically adjusting the customer's service profile. In FIG. 3 this storage entity is shown for convenience as the Policy Database (PD) 350.

An example of the operation of the RURCM 300 component of the platform 700 is now provided. Consider, for example, when a voice call is initiated, the MSC 100 (VBS 110) opens a logical connection to the RURCM 300, indicating the callee/caller phone numbers. The RURCM 300 responds by first querying the PD 350 for the customer's current prepaid profile, the PD 530 having record of, among other things, the number of residual minutes. Once the PD 350 responds with the customer profile, the RURCM 300 is able to monitor (in real-time) the resource usage of the ongoing call.

Further assume in this example that the user, in parallel, activates data sessions that are managed by the PDSN 150 (DBS 160). The PDSN 150 also opens a real-time logical connection to the RURCM 300. This connection is used by the RURCM 300 to monitor the resource consumption on the data path. Using real-time information about resource usage by the customer, the RURCM 300 decides at what point one or more of the ongoing sessions/connections should be terminated. After making this decision, the RURCM 300 instructs the appropriate network switch (the MSC 100 in this example) to terminate the ongoing call/session, thereby ensuring that the customer only has access to whatever was specified in the prepaid contract. In addition to terminating the connection, the RURCM 300 also updates the network databases, principally the HLR 175, with modifications to the prepaid customer's profile. Such modifications ensure that future unauthorized access by the prepaid consumer is effectively blocked during the call session initiation phase.

In the preferred embodiment of techniques for supporting prepaid integrated voice and data services, the implementation of the RURCM 300 is as an integral part of the cellular enterprise integration platform 700. Accordingly, a generic configuration method is provided, that includes, but is not limited to, the following logically distinct components. First are back-end integration engine adaptors (745) to support regular signaling protocols for configuration of network elements, such GSM MAP or IS-41 messages. These adaptors provide support for Intelligent Network (IN) messaging, which is considered important in some embodiments as it serves as an effective way for real-time control of network switches without the need for bandwidth-expensive techniques, such as high-frequency polling of switch states. Use of the JMS-based messaging architecture is also preferred, which permits specification of the priority of transmitted messages (e.g. real-time, high priority, non-real time). In some embodiments the priority transmission of messages is considered critical for support usage control in the prepaid service framework. Implementation of the RURCM 300 in the XML programming language is also preferred. For example, by using XML it is possible for PD 350 rules to be passed to the RURCM 300 based on the current view of the network usage by a specific customer.

The GUI 715 allows the user to define the customer-specific policies using the drag-and-drop utility. Accordingly, the processing flow of the RURCM 300 can be specified using the GUI 715, which is responsible for generating XML-compliant code from the visual representation of the service logic, and for exporting the XML-compliant code to, for example, the integration engine 740 for implementing the RURCM 300 module.

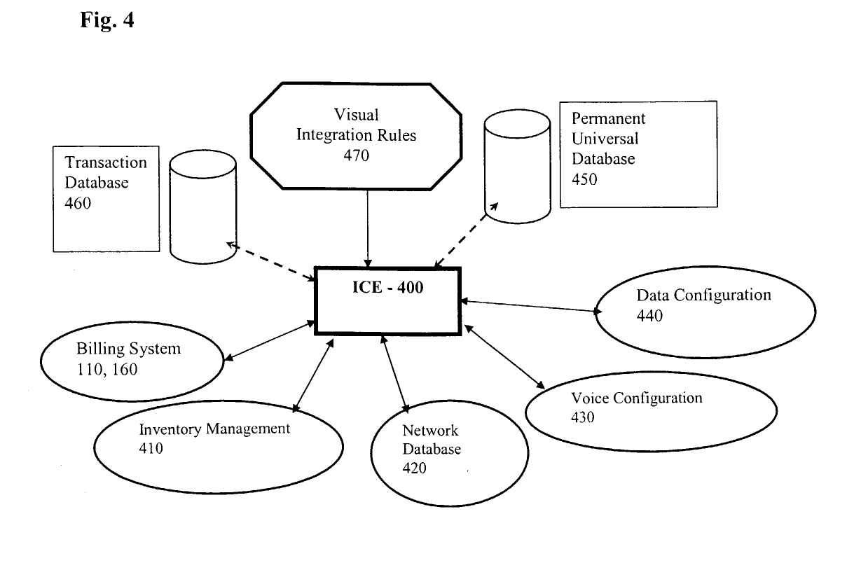

A discussion is now made of methods and apparatus for providing the integrated provisioning of both voice and data services in the wireless cellular network. A preferred embodiment (FIG. 4) for an integrated configuration of multiple devices is based on creating an Integrated Configuration Engine (ICE) 400 that effectively coordinates the different configuration systems. To provide flexibility, the network operator is enabled to create and modify the relationship between the different configuration systems and specify the parameters that should be synchronized across multiple systems. The ICE 400 is responsible for maintaining a single integrated view of all the services, and associated parameters, for a single user. To achieve this functionality the ICE 400 includes a configurable database 460 that stores all the parameters of interest. As part of its interaction with the various configuration processes, the ICE 400 is responsible for specifying the values of the parameters that are externally provided to a specific configuration process. Additionally, situations will arise where a specific configuration process will generate data for export back to the ICE 400. In some embodiments this may be required or advantageous when a subsequent process may use a certain parameter in a coordinated fashion. As a simple example, the voice configuration utility 430 exports the handset identification, so that it may be subsequently used by the GPRS (data) configuration module 440. Thus, the ICE 400 preferably is capable of specifying a list of fields that it wishes a particular configuration module to export back. Since the same information may have different representations (or different nomenclature) in different systems, the ICE 400 is responsible for maintaining the mapping of names and representation formats across different systems.

FIG. 4 provides an overview of the Integrated Configuration Engine (ICE) 400. FIG. 4 shows the ICE 400 as it relates to various cellular system components including: billing systems 110, 160; inventory management systems 410; network database 420; voice configuration 430; data configuration 440; a Permanent Universal Database 450; a Transaction Database 460; and a Visual Integration Rules system 470.

Thus, aspects of the ICE 400 operation are described by the following properties and techniques. A rule-based specification 470 informs the ICE 400 module about the various configuration entities that the ICE 400 is expected to interface with, and also the sequence in which these processes are to be invoked. As part of the rules and the process description, the ICE 400 module is also informed about the various data elements and parameters that must be exchanged between different systems. This description also specifies which parameters have global significance and are unique across all systems, as well as their potential representation format and nomenclature in specific systems. The ICE 400 module is then responsible for using these rule-sets to manage the sequential interaction between the individual configuration systems 430, 440.

In addition, configuring a particular customer for both voice and data may require multiple interactions between inventory systems 410, credit rating systems, billing systems 110, 160, network database 420 and switch configuration systems and other systems. The ICE 400 module is responsible for maintaining the consistency of data and state across multiple such systems. This is an important feature of the ICE 400, since different systems may have different semantics for message exchange with the central ICE 400 controller. Thus, some configuration systems 430, 440 may be interactive and based on a query-response mode of operation; other systems may perform off-line or batch processing, and thus provide responses after varying degrees of latency. Since it may not be feasible to perform such a process entirely sequentially, the ICE 400 may run configuration operations in parallel wherever feasible. Since such parallelism can give rise to problems of state synchronization, especially when one or more of the intermediate configuration processes fails, the ICE 400 is also responsible for performing operations such as complete and partial rollback to maintain the integrity of the underlying systems. To facilitate this operation, the ICE 400 module stores all transient operational state in its own internal database; and transactional atomicity is assured by having the ICE 400 undo all related operations in the case of intermediate failure.

The ICE 400 may have its own representation of parameters and processing rules, but it should be understood that the different provisioning systems will likely have their own data formats and interfaces. Thus, the ICE 400 functionality depends on the presence of multiple adaptors, which are responsible for performing protocol, message and data translation between the ICE 400 and the associated systems and sub-systems.

In the preferred embodiment the ICE 400 is employed for the integration of provisioning of both voice and data services. The ICE 400 is implemented as part of the enterprise integration platform 700 for cellular networks, which provides most of the functional primitives necessary for the creation of ICE 400, including, but not limited to, the framework 710 that provide the visual interface to specify the interaction between different software systems, and that converts the visual representation into a set of XML-coded rules that can then be invoked to perform the actual integration. The back-end integration engine 740 provides the adaptors 745 necessary to interface to different business support systems, and also provides the messaging architecture to exchange messages across multiple systems.

With the cooperation of the process integration engine 710 and the back-end integration engine 740, ICE 400 can be implemented as a part of the XML-based integration platform 700. Other aspects of the technique for integrated provisioning of voice and data services include, but are not limited to, the use of the JMS-based messaging architecture to communicate between ICE 400 and the associated configuration systems. This architecture provides for reliable message exchange primitives, as well as setting up notification functions that are invoked on successful completion of a specific configuration activity. Also of interest is the storage of the internal state of a transaction, including the values of various assigned parameters, in the integration database (e.g., an Oracle-based integration database) to support transaction atomicity and rollback. Since the XML rule-set also specifies the structural contents of the transactional database 460, modifying the information content of the database can be achieved by simply modifying the XML rule set. The ICE 400 also creates a Universal Customer Record (UCR) that provides a single point of entry to all the configuration tasks associated with a specific user. The fields of this UCR are customizable and are based on the associated XML rules. The UCR contains the customer's representation in various systems, as well as the mappings that transform a specific parameter in one system into an equivalent parameter in another system. The UCR is preferably implemented as an Internet-enabled database that can itself be accessed by other authorized systems, and is shown in FIG. 4 as the Permanent Universal database 450.

The creation of the customizable ICE 400 rule-set is part of the GUI 715 functionality. Through the use of the drag-and-drop interface a cellular service provider can readily define the precise interactions between the different business systems. Moreover, in some embodiments, a standard set of (modifiable) templates, which capture the most common configuration tasks, may be used to supplement the activity of the GUI 715 portion of the integration platform 700.

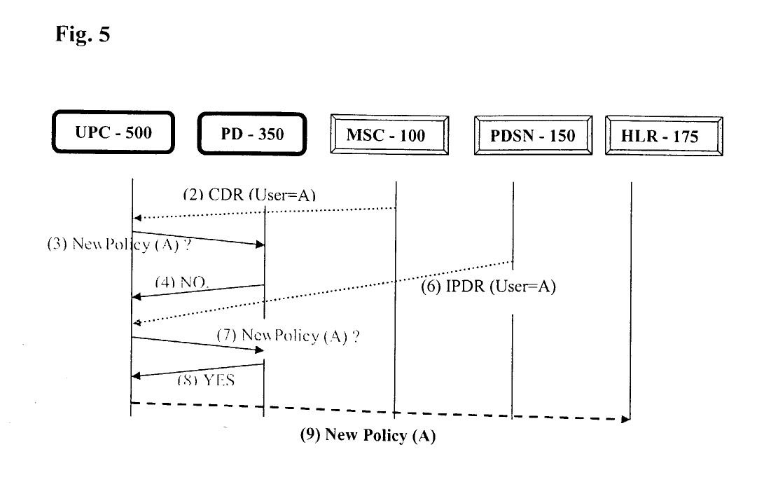

Described now is a method for using an integration platform to support the dynamic modification of customer access profiles in a cellular telecommunications architecture that supports both voice and data. Accordingly, a further aspect of this invention involves use of a Unified Policy Controller (UPC) 500, as shown in FIG. 5, which effectively unifies the two disparate (voice and data) views of a single customer. The UPC 500 provides, among other things, the ability to adaptively and dynamically modify a customer's profile. The UPC 500 is responsible for querying one or more billing systems 110, 160 (or alternatively, the network control entities, the VSCC and the DSCC) and then combines the usage statistics into a single representation of the voice and data services accessed by the customer. Since the billing systems 110, 160 may export such information in non-real time, that is, in an offline fashion, the UPC 500 may directly interface with the appropriate network entities, such as the MSC 100 and PDSN 150, to obtain usage records in a relatively time bound fashion.

The UPC 500 is preferably implemented as a separate functional entity that is independent of and distinct from the billing systems 110, 160. Among other things, the UPC enforces policies that call for modification of a customer's profile based on the customer's usage. The UPC 500 does not itself compute the customer's final bill. After obtaining the combined usage records, the UPC 500 is responsible for consulting a Policy Database (PD) 350 for the customer to determine any needed changes to or modification of the customer's current profile in the HLR 175. The policy database 350 is considered to be an integral part of the software system, and at least two different embodiments of interaction with the policy database 350 are possible.

The first embodiment of interaction with the policy database 350 involves a query-based model, where the UPC 500 simply checks the policy database 350 on every new resource consumption record. In this mode, the UPC 500 need not make determinations as to whether modifications to the profile are necessary.

The second embodiment of interaction with the policy database 350 involves a trigger-based model, where the UPC 500 does not check the policy database 350 for each new report on resource consumption, but only when such resource consumption exceeds or reaches configurable thresholds (trigger points). In this model, the UPC 500 is employed to store and track thresholds. While the UPC 500 can decide when a new lookup of the policy database 350 is necessary, it need not, however, store the modifications themselves. The modified policy itself is stored in the policy database 350 and retrieved through appropriate interfaces. One skilled in the art will recognize that this second embodiment minimizes unnecessary accesses to the policy database 350, and will generally result in more scalable performance characteristics.

A step in this integration process is the modification of the user profile in the appropriate network databases. Almost all cellular systems use a master database, also referred to as the HLR 175, which effectively serves as the query point for all cellular switches. Thus, it is enough for the UPC 500 to make the necessary customer policy changes in the HLR 175. The UPC 500 may directly interface to the HLR 175, which will typically require the translation of policies into vendor-specific HLR 175 formats, or the UPC 500 may interface to a more standard operator-supplied HLR 175 configuration utility.

FIG. 5 is a logic diagram of the various elements, as well as a sequence of logical message flows and actions illustrating the functionality of integrated policy management in a cellular network. In the example shown in FIG. 5, the UPC 500 communicates directly with the network elements, such as the PDSN 150, MSC 100 and HLR 175.

Reviewing FIG. 5, assume that User A first makes a voice call. This information is stored in the MSC 100. At the end of the call, the MSC 100 updates the voice billing system 110, and also notifies the UPC 500 of customer A's new Call Detail Records (CDR). On receiving this information, the UPC 500 first matches this specific CDR to User A's integrated usage record to determine the composite (voice and data) resource consumption. The UPC 500 then queries the policy database 350 to determine if any profile modification is necessary. In this particular example, the policy does not currently call for any further action; so none is invoked.

Assume now that User A further invokes a data service which then uses the PDSN 150. The PDSN 150 monitors the level of service and resource consumption (for example data throughput and duration). The PDSN 150 periodically (or at the termination the data connection) informs the data billing system 160, as well as the UPC 500 of corresponding resource usage. The UPC 500 updates the integrated usage record and then queries the policy database 350 for any changes needed to the customer's usage profile. In this case, the policy database 350 indicates that User A's voice privileges should be temporarily revoked, while data privileges remain intact. Thus, a modification to User A's access profile is needed at the HLR 175.

In the preferred embodiment the UPC 500 is a part of the cellular enterprise integration platform 700. Accordingly, a generic configuration method is provided that includes, but is not limited to, the following logically distinct components. First are the adaptors 745 integrated to the backend integration system that allow the UPC 500 component to interface with various network elements (such as the HLR 175 and the MSC 100) and to additional support systems (such as billing systems 110. 160). This communication is achieved using the backend integration system's JMS-based messaging primitives. In keeping with the XML-based architecture of the remaining platform 700 components, the interface to the policy database 350 is also implemented using XML rules. These rules allow the UPC 500 engine to appropriately fashion queries to the policy database 350 and then appropriately respond to the results of the queries. Thus, the UPC 500 engine can be implemented as an extended component of the integration engine 740 rules agent. The GUI 715 component of the platform 700 allows the user to define the customer-specific policies using the drag-and-drop utility. The GUI 715 is responsible for deriving the XML rule-set from the GUI representation and forwarding this to the UPC 500 component. The rules set can include the various trigger points (for example, where the user policy information exhibits a change), as well as information regarding the policy details; and, since the policy database 350 may itself store data in other formats, one further possible function of the UPC 500 component may be to use additional adaptors to convert and store the XML-based policy information in other data storage formats.

In some embodiments, the user may wish that the UPC 500 impose stringent messaging latency bounds on the EJB-based messaging sub-system, and may further desire special primitives to establish dedicated connections to network elements (such as the MSC 100 and PDSN 150) to support real-time tracking of a live call session.

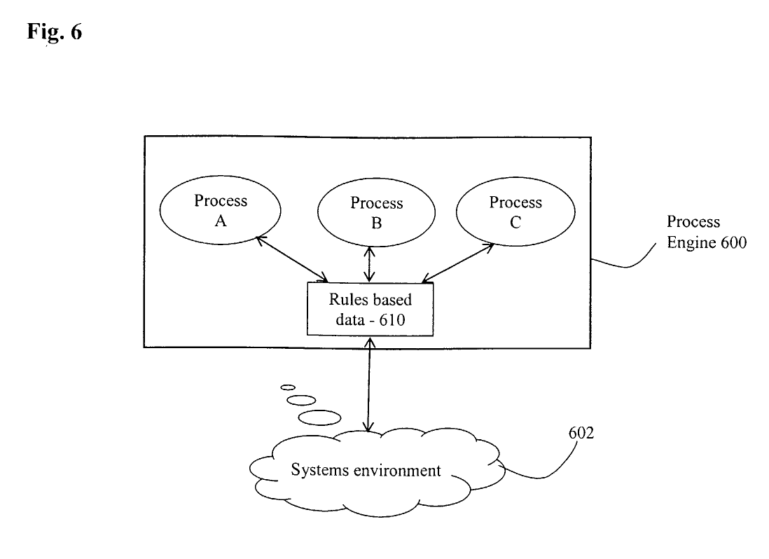

In a further aspect this invention provides a method and apparatus for creating unified business processes that integrate transactions in multiple disparate systems using an intelligent software platform. A process engine 600 (FIG. 6), which may be referred to as a Meta Process Engine (MPE), tracks information about business processes and, based on information derived from the tracking, identifies properties and creates rules about the business processes. The MPE 600 includes domain specific primary rules, which are augmented by user generated as well as system generated rules. The MPE 600 monitors the properties of the processes that are created and assigns values. The process combinations that make a rule are validated at the time of creation of the rule. The MPE 600 also incorporates monitoring to identify specific process steps based on preceding and following values within a rule chain. The MPE 600 is responsible for maintaining integrity of the processes as well as enabling users to create new rules quickly and efficiently. Notably, the MPE 600 is not a process engine by itself. The MPE 600 instead serves as a guide to efficient processes and isolates the user from the task of independently ensuring process compatibility with the different systems in the environment 602.

In the preferred embodiment the MPE 600 is a part of the cellular enterprise integration platform 700. Accordingly, a generic configuration method is provided that includes, but is not limited to, the following logically distinct components. The adaptors 745 integrated to the back-end integration system 740 enable the MPE 600 to interface to various billing systems 110, 160 and, if necessary, to network elements (such as, but not limited to, the HLR 175 and MSC 100). This communication is achieved using an integration engine using JMS-based messaging architecture and includes support for the UsageQuery and RateConfigure message primitives. A rules-based data component 610 is implemented using rules consistent with the MPE 600. In the preferred embodiment, XML rules are followed, and provide for XML message formats to determine the appropriate rating rules to be applied to a specific customer. Thus, the MPE 600 essentially uses specific algorithms to ensure rule integrity, and may be integrated as an extended component of a business process manager. The GUI 715 allows the user to define the customer-specific policies using the drag-and-drop utility. Accordingly, the rules applicable to the rules based data 610 can be specified by such a utility. The GUI 715 is responsible for deriving the XML rule-set from the graphical user interface representation and forwarding this to the MPE 600.

One skilled in the art will recognize that embodiments of the invention disclosed herein are illustrative of the invention, and are not limiting in any way. That is, the invention disclosed herein is not limited to certain wireless telecommunication systems, specific to certain operational support systems, or limited by factors such as the type of the telecommunication system or of the underlying cellular system air interfaces standards and protocols. This invention, and variations thereof, may be practiced in a variety of settings. It is within the ambit of the teachings contained herein to use this invention, and variations thereof, in other applications, while remaining within the scope of this invention.

What is claimed is:

1. A method for operating a telecommunication system network comprising at least first resources and second resources, comprising:
providing a resource consumption monitor;
using the resource consumption monitor to query the first resources and the second resources to obtain, for a particular customer, an integrated record descriptive of the consumption of the first and second resources by the customer; and
based on the integrated record and a rules set, communicating an appropriate rate schedule to a first resources billing system and to a second resources billing system.

2. A method as in claim 1, where the first resources comprise voice communication resources, and where the second resources comprise data communication resources.

3. A method as in claim 2, where the voice communication resources comprise a voice controller node, and where the second resources comprise a data controller node.

4. A method as in claim 1, where the resource consumption monitor queries the first resources using a first customer identifier and queries the second resources using a second customer identifier.

5. A method as in claim 4, where the first resources comprise voice communication resources, where the second resources comprise data communication resources, and where the first customer identifier comprises a telephone number and the second customer identifier comprises a data communications network address.

6. A method as in claim 1, where the first resources and the second resources respond to the query with an aggregate record of customer resource utilization.

7. A method as in claim 1, where the rules set comprises a rules engine that is responsive to a rate query from the resource consumption monitor, for a specific customer, to return a rate response that is applicable to that customer, and where the rate response is used to derive the appropriate rate schedule that is communicated to the first resources billing system and to the second resources billing system.

8. A method as in claim 1, where the first resources billing system and the second resources billing system each comprises one of a pre-paid or a post-paid billing system.

9. A telecommunication system network comprising at least first resources and a first resources billing system, and second resources and a second resources billing system, the telecommunication system network further comprising:
a rules set; and
a resource consumption monitor operable to query the first resources and the second resources to obtain, for a particular customer, an integrated record descriptive of the consumption of the first and second resources by the customer; said resource consumption monitor being coupled to the first resources billing system and to the second resources billing system, and responsive to the integrated record and to the rules set, for communicating an appropriate rate schedule to the first resources billing system and to the second resources billing system.

10. A telecommunication system network as in claim 9, where the first resources comprise voice communication resources, and where the second resources comprise data communication resources.

11. A telecommunication system network as in claim 10, where the voice communication resources comprise a voice controller node, and where the second resources comprise a data controller node.

12. A telecommunication system network as in claim 9, where the resource consumption monitor queries the first resources using a first customer identifier and queries the second resources using a second customer identifier.

13. A telecommunication system network as in claim 12, where the first resources comprise voice communication resources, where the second resources comprise data communication resources, and where the first customer identifier comprises a telephone number and the second customer identifier comprises a data communications network address.

14. A telecommunication system network as in claim 9, where the first resources and the second resources respond to the query with an aggregate record of customer resource utilization.

15. A telecommunication system network as in claim 9, where the rules set comprises a rules engine that is responsive to a rate query from the resource consumption monitor, for a specific customer, to return a rate response that is applicable to that customer, and where the rate response is used to derive the appropriate rate schedule that is communicated to the first resources billing system and to the second resources billing system.

16. A telecommunication system network as in claim 9, where the first resources billing system and the second resources billing system each comprises one of a pre-paid or a post-paid billing system.

17. A method for operating a telecommunication system network comprising at least first resources and second resources the use of which is pre-paid by a customer, comprising:
providing a resource consumption monitor;
using the resource consumption monitor to monitor usage of the first resources and the second resources during at least one connection to obtain, for a particular customer, customer usage information;
comparing the customer usage information to a customer pre-paid usage limits profile for terminating the at least one connection if usage limits for at least one of the first or second resources are equaled; and
updating the customer pre-paid usage limits profile.

18. A method as in claim 17, where the first resources comprise voice communication resources, and where the second resources comprise data communication resources.

19. A method as in claim 17, where updating the customer pre-paid usage limits profile includes modifying a customer record at a home location register to prevent the customer from gaining access to a resource whose pre-paid usage limit for that customer has been equaled.

20. A method as in claim 17, where usage of the first resource reduces an available amount of usage of the second resource.

21. A method as in claim 17, where usage of the first resource or the second resource reduces an available amount of usage for both the first and the second resources.

22. A method as in claim 17, where the resource consumption monitor monitors usage by periodically polling at least active ones of a first resources control element and a second resources control element.

23. A method as in claim 17, where the resource consumption monitor monitors usage by receiving updates from at least active ones of a first resources control element and a second resources control element, the updates being sent when usage reaches a threshold amount.

24. A method as in claim 17, where updating the customer pre-paid usage limits profile includes modifying a customer record at a home location register, and where the resource consumption monitor monitors usage of resources with a finer granularity than home location register is capable of monitoring resource consumption.

25. A telecommunication system network comprising at least first resources and second resources the use of which is pre-paid by a customer, the telecommunication system network further comprising:
a network element storing a customer pre-paid usage limits profile; and
a resource consumption monitor for monitoring usage of the first resources and the second resources during at least one connection to obtain, for a particular customer, customer usage information, for comparing the customer usage information to the customer pre-paid usage limits profile for terminating the at least one connection if usage limits for at least one of the first or second resources are equaled, and for updating the customer pre-paid usage limits profile.

26. A telecommunication system network as in claim 25, where the first resources comprise voice communication resources, and where the second resources comprise data communication resources.

27. A telecommunication system network as in claim 25, where the network element comprises a home location register, and where updating the customer pre-paid usage limits profile is used to prevent the customer from gaining access to a resource whose pre-paid usage limit for that customer has been equaled.

28. A telecommunication system network as in claim 25, where usage of the first resource reduces an available amount of usage of the second resource.

29. A telecommunication system network as in claim 25, where usage of the first resource or the second resource reduces an available amount of usage for both the first and the second resources.

30. A telecommunication system network as in claim 25, where the resource consumption monitor monitors usage by periodically polling at least active ones of a first resources control element and a second resources control element.

31. A telecommunication system network as in claim 25, where the resource consumption monitor monitors usage by receiving updates from at least active ones of a first resources control element and a second resources control element, the updates being sent when usage reaches a threshold amount.

32. A telecommunication system network as in claim 25, where the network element comprises a home location register, and where the resource consumption monitor monitors usage of resources with a finer granularity than the home location register is capable of monitoring resource consumption.

33. A method for operating a telecommunication system network comprising at least first customer services associated with a first customer configuration system and second customer services associated with a second customer configuration system, comprising:
providing an integrated configuration engine;
storing in a database of the integrated configuration engine, for each customer, customer parameters used by each of the first and second customer configuration systems; and
bidirectionally communicating between the database and the first and second customer configuration systems, via the integrated configuration engine, customer parameters and modified customer parameters for enabling configuration processes to be executed by said first and second customer configuration systems.

34. A method as in claim 33, where the first customer services comprise voice communication services, and where the second customer services comprise data communication services.

35. A method as in claim 33, where bidirectionally communicating comprises specifying to a customer configuration system a list of the parameters to be exported back to the integrated configuration engine.

36. A method as in claim 33, where the integrated configuration engine comprises means for mapping parameter names and representation formats between communication services.

37. A method as in claim 33, where said configuration processes comprise operating at least inventory systems and billing systems.

38. A method as in claim 33, where the integrated configuration engine comprises means for parallelizing a plurality of configuration operations.

39. A method as in claim 38, further comprising storing a record of transient operational state during the parallelizing of the plurality of configuration operations, enabling operations to be undone upon a failure during the parallelizing of the plurality of configuration operations.

40. A method as in claim 33, where the integrated configuration engine is coupled to the first and second customer configuration systems through first and second adapters enabling protocol, message and data translation, as needed, between the integrated configuration engine and the first and second customer configuration systems, respectively.

41. A method as in claim 33, where the customer parameters are stored in a universal customer record comprising the representation of the customer in various systems, and mappings for translating a specific parameters in one system to a parameter for use in another system.

42. A telecommunication system network comprising at least first customer services associated with a first customer configuration system and second customer services associated with a second customer configuration system, further comprising an integrated configuration engine comprising a database for storing, for each customer, customer parameters used by each of the first and second customer configuration systems, and means for bidirectionally communicating between the database and the first and second customer configuration systems, via the integrated configuration engine, customer parameters and modified customer parameters for enabling configuration processes to be executed by said first and second customer configuration systems.

43. A telecommunication system network as in claim 42, where the first customer services comprise voice communication services, and where the second customer services comprise data communication services.

44. A telecommunication system network as in claim 42, where said means for bidirectionally communicating comprises means for specifying to a customer configuration system a list of the parameters to be exported back to the integrated configuration engine.

45. A telecommunication system network as in claim 42, where the integrated configuration engine comprises means for mapping parameter names and representation formats between communication services.

46. A telecommunication system network as in claim 42, where said configuration processes comprise at least inventory systems and billing systems.

47. A telecommunication system network as in claim 42, where the integrated configuration engine comprises means for parallelizing a plurality of configuration operations.

48. A telecommunication system network as in claim 47, further comprising means for storing a record of transient operational state during the parallelizing of the plurality of configuration operations, enabling operations to be undone by the integrated configuration engine upon a failure during the parallelizing of the plurality of configuration operations.

49. A telecommunication system network as in claim 42, where the integrated configuration engine is coupled to the first and second customer configuration systems through first and second adapters enabling protocol, message and data translation, as needed, between the integrated configuration engine and the first and second customer configuration systems, respectively.

50. A telecommunication system network as in claim 42, where the customer parameters are stored in a universal customer record comprising the representation of the customer in various systems, and mappings for translating a specific parameters in one system to a parameter for use in another system.

51. A method for operating a telecommunication system network comprising at least first resources and second resources the use of which is specified by a policy database, comprising:
providing a unified policy controller;
using the unified policy controller to monitor usage of the first resources and the second resources to obtain, for a particular customer, combined customer usage information; and
comparing the combined customer usage information to information stored in the policy database and dynamically modifying a customer service profile, if needed, based on the combined customer usage information and the information stored in the policy database.

52. A method as in claim 51, where the first resources comprise voice communication resources, and where the second resources comprise data communication resources.

53. A method as in claim 51, where dynamically modifying includes modifying the customer service profile at a home location register.

54. A method as in claim 51, where usage of the first resource reduces an available amount of usage of the second resource.

55. A method as in claim 51, where usage of the first resource beyond a specified limit prohibits usage of the second resource.

56. A method as in claim 51, where the unified policy controller consults the policy database by sending a query to the policy database upon receipt of a resource consumption record from controller associated with the resource for which the resource consumption record was received.

57. A method as in claim 51, where the unified policy controller consults the policy database by sending a query to the policy database upon a particular resource consumption reaching a triggering level.

58. A method as in claim 51, where the first resources and the second resources each comprise one of a pre-paid or a post-paid billing system.

59. A telecommunication system network comprising at least first resources and second resources for use by a customer, the telecommunication system network further comprising:
a first network element storing a policy database;
a second network element storing a customer service profile; and
a unified policy controller for monitoring usage of the first resources and the second resources to obtain, for a particular customer, combined customer usage information and for comparing the combined customer usage information to information stored in the policy database, the unified policy controller dynamically modifying the customer service profile, if needed, based on the combined customer usage information and the information stored in the policy database.

60. A telecommunication system network as in claim 59, where the first resources comprise voice communication resources, and where the second resources comprise data communication resources.

61. A telecommunication system network as in claim 59, where the second network element comprises a home location register.

62. A telecommunication system network as in claim 59, where usage of the first resource reduces an available amount of usage of the second resource.

63. A telecommunication system network as in claim 59, where usage of the first resource beyond a specified limit prohibits usage of the second resource.

64. A telecommunication system network as in claim 59, where the unified policy controller consults the policy database by sending a query to the policy database upon receipt of a resource consumption record from controller associated with the resource for which the resource consumption record was received.

65. A telecommunication system network as in claim 59, where the unified policy controller consults the policy database by sending a query to the policy database upon a particular resource consumption reaching a triggering level.

66. A telecommunication system network as in claim 59, where the first resources and the second resources each comprise one of a pre-paid or a post-paid billing system.

67. A method for operating a telecommunication system network comprising a plurality of business processes, comprising:
providing a meta process engine; and
tracking information concerning business processes and, based on information derived from the tracking, identifying properties of and creating rules concerning business processes;
the meta process engine including domain specific primary rules augmented by user and system generated rules, where process combinations that comprise a rule are validated at the time of creation of the rule.

68. A method as in claim 67, where the meta process engine identifies specific process steps based on preceding and following values within a rule chain.

69. A platform for integrating operational support systems within a telecommunications system, comprising:
a framework portion comprising a graphical user interface having a drag and drop capability for enabling a user to define rules-based processes;
a mapping portion comprising a rules engine providing data mapping for the defined processes and linking for interfacing processes to front-end and back-end services of the telecommunications system; and
an integration engine portion comprising adapters for bidirectionally coupling to the front-end and back-end services for enabling execution of the defined processes.

70. A platform as in claim 69, where one of said processes comprises a resource consumption monitor operable to query, through said adapters, first resources and second resources of the telecommunications system to obtain, for a particular customer, an integrated record descriptive of the consumption of the first and second resources by the customer; said resource consumption monitor being coupled to a first resources billing system and to a second resources billing system through said adapters, and responsive to the integrated record and to a rules set, for communicating an appropriate rate schedule to the first resources billing system and to the second resources billing system.

71. A platform as in claim 69, where one of said processes comprises a resource consumption monitor for monitoring through said adapters usage of first resources and second resources of the telecommunications system during at least one connection to obtain, for a particular customer, customer usage information, for comparing the customer usage information to a customer pre-paid usage limits profile for terminating the at least one connection if usage limits for at least one of the first or second resources are equaled, and for updating the customer pre-paid usage limits profile accordingly.

72. A platform as in claim 69, where the telecommunications system comprises at least first customer services associated with a first customer configuration system and second customer services associated with a second customer configuration system, where one of said processes comprises an integrated configuration engine comprising a database for storing, for each customer, customer parameters used by each of the first and second customer configuration systems, and means for bidirectionally communicating between the database and the first and second customer configuration systems, via the integrated configuration engine and said adapters, customer parameters and modified customer parameters for enabling configuration processes to be executed by said first and second customer configuration systems.

73. A platform as in claim 69, where one of said processes comprises a unified policy controller coupled to a first network element storing a policy database and to a second network element storing a customer service profile, said unified policy controller monitoring through said adapters usage of first resources and second resources of the telecommunications system to obtain, for a particular customer, combined customer usage information, and for comparing the combined customer usage information to information stored in the policy database, the unified policy controller dynamically modifying the customer service profile, if needed, based on the combined customer usage information and the information stored in the policy database.

74. A platform as in claim 69, where one of said processes comprises a meta process engine for tracking information concerning business processes and, based on information derived from the tracking, for identifying properties of and creating rules concerning business processes, the meta process engine including domain specific primary rules augmented by user and system generated rules, where process combinations that comprise a rule are validated at the time of creation of the rule.
